(19) United States
(12) Patent Application Publication
(10) Pub. No.: US 2026/0289839 A1
(43) Pub. Date: Sep. 24, 2026

(54) ELECTRONIC DEVICE

(71) Applicant: CANON KABUSHIKI KAISHA, Tokyo (JP)

(72) Inventor: EICHI ARAI, Kanagawa (JP)

(21) Appl. No.: 19/537,780

(22) Filed: Feb. 12, 2026

(30) Foreign Application Priority Data
Mar. 21, 2025 (JP) 2025-047189

(51) Int. Cl. G06T 11/26; G06F 3/04845; G06T 3/40

(52) U.S. Cl. CPC G06T 11/26; G06F 3/04845; G06T 3/40; G06T 2200/24

(57) ABSTRACT

An electronic device executes acquires an image, generates a graph including a first axis indicating coordinates of the image in a predetermined direction and a second axis indicating a gradation value of the image, performs control to display the image and the graph, and performs, in response to a user operation, control to switch display of the image and the graph between first display and second display, the first display being display in which a display position of coordinates indicated by the first axis and a display position of the coordinates of the image do not substantially match in the predetermined direction, the second display being display in which the display position of the coordinates indicated by the first axis and the display position of the coordinates of the image substantially match in the predetermined direction.

### BACKGROUND

### Field of the Technology

The present disclosure relates to an electronic device, and more particularly to a technique for displaying a captured image and an image of a waveform monitor.

### Description of the Related Art

There is application software that is wirelessly connected to a camera and can remotely operate the camera. The application software operates on a remote terminal such as a smartphone, a tablet device, or a personal computer, and is useful when a user wants to remotely control the camera.

In the application software, a live view image (LV image) of the camera may be acquired to display the live view image on a screen of a remote terminal. The LV image and an operation member may be displayed on one screen so that a user can operate the camera while checking the LV image. Furthermore, an object that can be moved (and scaled), such as a feature image representing a feature of the LV image, may be displayed.

As the feature image, an image of a waveform monitor (WFM image) may be displayed. The WFM image is, for example, a graph in which the horizontal axis indicates the horizontal coordinates (coordinates in the horizontal direction) of the LV image and the vertical axis indicates the luminance value of the LV image, and indicates the distribution of the luminance values of the LV image. In general, the WFM image has a scale on the vertical axis and a scale on the horizontal axis.

Japanese Patent Laid-Open No. 2012-134767 discloses a technique of superimposing a WFM image having no scale on an LV image.

According to the technique disclosed in Japanese Patent Laid-Open No. 2012-134767, the horizontal display position (display position in the horizontal direction) of the coordinates indicated by the horizontal axis of the WFM image and the horizontal display position of the coordinates of the LV image can be matched. However, since the WFM image does not have a scale, the user cannot easily grasp the absolute luminance value although the user can easily grasp the relative luminance value.

When the general WFM image having the scale is displayed, the user can easily grasp the absolute luminance value. However, in a case where the horizontal width (width in the horizontal direction) of the LV image is equal to the horizontal width of the screen, the horizontal display position of the coordinates indicated by the horizontal axis of the WFM image cannot be aligned with the horizontal display position of the coordinates of the LV image due to the presence of the display area of the scale. In that case, the user cannot easily grasp the (detailed) correspondence relationship between the luminance value and the position in the LV image.

### SUMMARY

The present disclosure provides a technique to enable a user to easily grasp an absolute luminance value of an image and a correspondence relationship between the luminance value and a position in the image.

An electronic device according to the present disclosure includes a processor, and a memory storing a program which, when executed by the processor, causes the electronic device to execute an acquisition process of acquiring an image, execute a generation process of generating a graph including a first axis indicating coordinates of the image in a predetermined direction and a second axis indicating a gradation value of the image, and execute a control process of performing control to display the image and the graph, wherein in response to a user operation, in the control process, control is performed to switch display of the image and the graph between first display and second display, the first display being display in which a display position of coordinates indicated by the first axis and a display position of the coordinates of the image do not substantially match in the predetermined direction, the second display being display in which the display position of the coordinates indicated by the first axis and the display position of the coordinates of the image substantially match in the predetermined direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration example of a system.

FIG. 2 is a block diagram illustrating a configuration example of a camera.

FIG. 3 is a block diagram illustrating a configuration example of a smartphone.

FIG. 4 is a schematic diagram illustrating a screen example of a camera control application.

FIG. 5 is a flowchart illustrating an operation of a smartphone according to a first embodiment.

FIG. 6 is a schematic diagram illustrating a display example of an LV image and a WFM image.

FIGS. 7A - 7C are schematic diagrams illustrating display examples of an LV image and a WFM image.

FIG. 8 is a schematic diagram illustrating a display example of an LV image and a WFM image.

FIGS. 9A and 9B are schematic diagrams illustrating display examples of an LV image and a WFM image.

FIG. 10 is a flowchart illustrating an operation of a smartphone according to a second embodiment.

FIGS. 11A and 11B are schematic diagrams illustrating display examples of an LV image and a WFM image.

### DESCRIPTION OF THE EMBODIMENTS

### First Embodiment

Hereinafter, a first embodiment of the present disclosure will be described.

### System Configuration

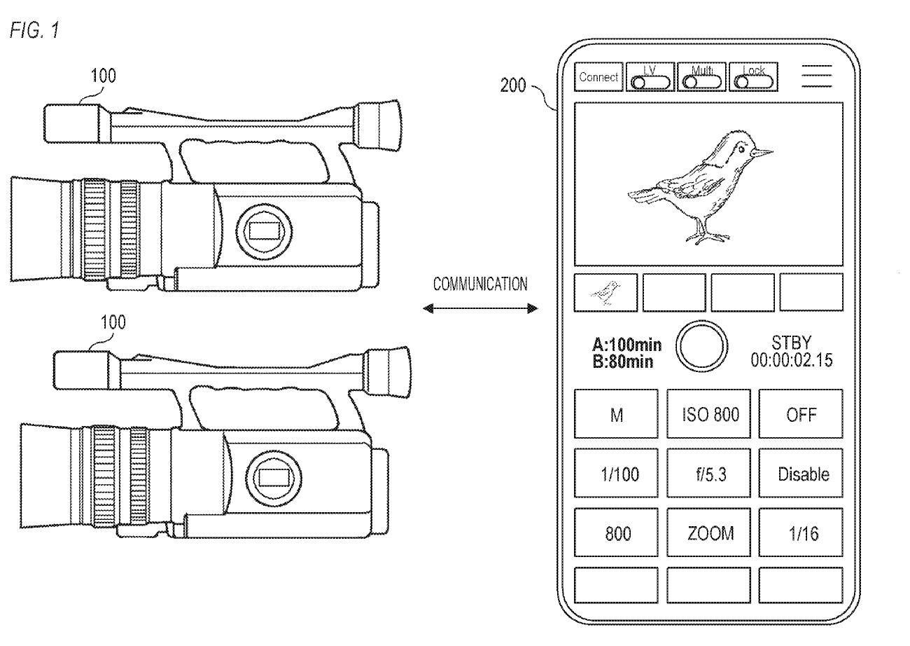

FIG. 1 is a schematic diagram illustrating a configuration example of a system according to the first embodiment. In the system of FIG. 1, a plurality of cameras 100 and a smartphone 200 are communicably connected to each other. FIG. 1 illustrates two cameras 100 but the number of the cameras 100 is not particularly limited. One camera 100 may be connected to the smartphone 200, or three or more cameras 100 may be connected to the smartphone 200. A communication system (standard) is also not particularly limited and may be, for example, Wi-Fi (registered trademark), Bluetooth (registered trademark), or a wireless communication system exclusive to a manufacturer. The communication between the cameras 100 and the smartphone 200 may be wireless communication or wired communication. A communication system in the wired communication is also not particularly limited and may be, for example, RS-232C, RS-422A, USB, or Ethernet (registered trademark). Any communication system capable of transmitting and receiving a video and transmitting and receiving a setting value of a camera is applicable.

### Configuration of Camera

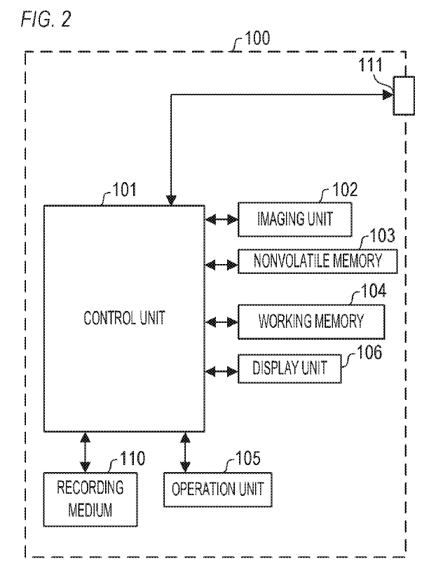

FIG. 2 is a block diagram illustrating a configuration example of the camera 100 (video camera) as an example of a data processing device according to the first embodiment. The data processing device is not limited to the camera 100. For example, the data processing device may be an electronic device such as a tablet device or a personal computer.

A control unit 101 controls each unit in the camera 100 according to an input signal and a program described below. Instead of causing the control unit 101 to control the entire camera 100, the processing may be shared by a plurality of hardware to control the entire camera 100.

An imaging unit 102 converts object light focused by a lens in the imaging unit 102 into an electrical signal, executes noise reduction processing or the like, and outputs image data that is digital data. The captured image data is accumulated in a buffer memory, is subjected to predetermined processing by the control unit 101, and is recorded in a recording medium 110.

A nonvolatile memory 103 is a nonvolatile memory that is electrically erasable and recordable, and stores a program described below to be executed by the control unit 101 or the like.

A working memory 104 is used as a buffer memory that temporarily stores the image data captured by the imaging unit 102, an image display memory of a display unit 106, a work area of the control unit 101, or the like.

An operation unit 105 is used for receiving an instruction for the camera 100 from a user. The operation unit 105 includes, for example, operation members operated by the user, such as a power button for instructing ON/OFF of a power supply of the camera 100, a release switch for instructing shooting, and a replay button for instructing replay of image data. The operation unit 105 also includes a touch panel formed in the display unit 106. The release switch includes a switch SW1 and a switch SW2. The switch SW1 is turned ON when the release switch enters a so-called half-pressed state. As a result, an instruction for executing shooting preparations such as autofocus (AF) processing, autoexposure (AE) processing, auto white balance (AWB) processing, and pre-flash (EF) processing is received. The switch SW2 is turned ON when the release switch enters a so-called full-pressed state. As a result, an instruction for executing shooting is received.

The display unit 106 displays a live view image (LV image) as a captured image showing an object substantially in real time, a shot (recorded) captured image, text for interactive operation, and the like. The display unit 106 is not necessarily built in the camera 100. It is only necessary that the camera 100 can be connected to the internal or external display unit 106 and has a display control function of controlling display of the display unit 106.

The recording medium 110 can store image data output from the imaging unit 102. The recording medium 110 may be attachable and detachable with respect to the camera 100 or may be built in the camera 100. The camera 100 only needs to have a function of accessing at least the recording medium 110.

The connection unit 111 is an interface for connection to an external device. The camera 100 can exchange data with the external device via the connection unit 111. The connection unit 111 includes, for example, an interface for communication with the external device via a wireless LAN. The control unit 101 implements wireless communication with the external device by controlling the connection unit 111.

Note that, the camera 100 can operate as a slave device in an infrastructure mode of wireless LAN communication. During operation as a slave device, the camera 100 can be connected to a peripheral access point (hereinafter, AP) to participate in a network formed by the AP. The camera 100 is one type of AP and can also operate as a simplified AP (hereinafter, simple AP) having a limited function. An AP is an example of a relay device. When the camera 100 operates as a simple AP, the camera 100 itself forms a network. A peripheral device of the camera 100 can recognize the camera 100 as an AP and participate in the network formed by the camera 100. A program for allowing the camera 100 to operate as described above is stored in the nonvolatile memory 103. Although the camera 100 is one type of AP, it is a simple AP not having a gateway function of transferring data received from a slave device to an Internet service provider or the like. Accordingly, even when the camera 100 receives data from another device participating in the network formed by the camera 100 itself, the camera 100 cannot transfer the received data to a network such as the Internet.

As described above, a communication system with the external device is not particularly limited. The connection unit 111 may be an interface for executing wired communication by a system such as RS-232C, RS-422A, USB, or Ethernet (registered trademark).

### Configuration of Smartphone

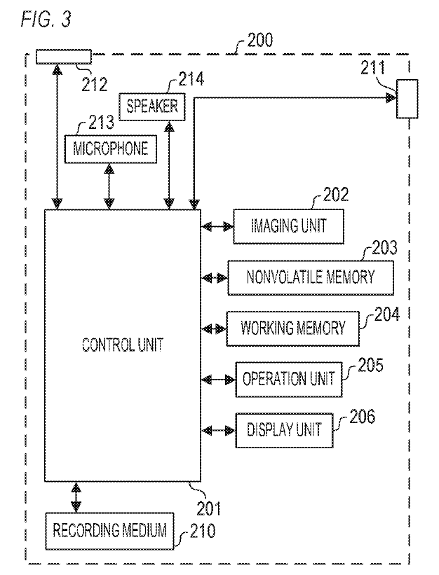

FIG. 3 is a block diagram illustrating a configuration example of the smartphone 200 as an example of a control device according to the first embodiment. The control device is not limited to the smartphone 200. For example, the control device may be an electronic device such as a digital camera, a mobile media player, a tablet device, a personal computer, or a mobile phone.

A control unit 201 controls each unit in the smartphone 200 according to an input signal or a program described below. Instead of causing the control unit 201 to control the entire smartphone 200, the processing may be shared by a plurality of pieces of hardware to control the entire smartphone 200.

An imaging unit 202 converts object light focused by a lens in the imaging unit 202 into an electrical signal, executes noise reduction processing or the like, and outputs digital data as image data. The captured image data is accumulated in a buffer memory, is subjected to predetermined processing by the control unit 201, and is recorded in a recording medium 210.

A nonvolatile memory 203 is a nonvolatile memory that is electrically erasable and recordable, and stores an operating system (OS) that is basic software to be executed by the control unit 201, various programs, and the like. A program for communication with the camera 100 is also stored in the nonvolatile memory 203, and is installed as a camera control application. The processing of the smartphone 200 is implemented by reading a program of the camera control application. The camera control application has a function for using basic functions (for example, a function of a wireless LAN, a function of Bluetooth, and a function of calling another application) of the OS installed in the smartphone 200. The camera control application has a remote shooting function of remotely operating and causing the camera 100 to shoot from the smartphone 200 while viewing the LV image obtained from the camera 100 by the smartphone 200. The camera control application has a remote viewing function of remotely viewing image data stored in a recording medium mounted on the camera 100 or receiving the image data. The OS of the smartphone 200 may have the functions of the first embodiment (for example, the function of the camera control application).

A working memory 204 is used as a buffer memory that temporarily stores the image data captured by the imaging unit 202, an image display memory of a display unit 206, a work area of the control unit 201, and the like.

An operation unit 205 is used for receiving an instruction for the smartphone 200 from the user. The operation unit 205 includes, for example, operation members operated by the user, such as a power button for instructing ON/OFF of a power supply of the smartphone 200 or a touch panel formed in the display unit 206.

The display unit 206 displays an image, text for interactive operation, or the like. The display unit 206 is not necessarily built in the smartphone 200. It is only necessary that the smartphone 200 can be connected to the internal or external display unit 206 and has a display control function of controlling display of the display unit 206.

The recording medium 210 can store image data output from the imaging unit 202, image data received from the camera 100, and the like. The recording medium 210 may be attachable and detachable with respect to the smartphone 200 or may be built in the smartphone 200. The smartphone 200 only needs to have a function of accessing at least the recording medium 210.

A connection unit 211 is an interface for connection to an external device. The smartphone 200 can exchange data with the external device via the connection unit 211. The connection unit 211 includes, for example, an interface for communication with the external device via a wireless LAN. The control unit 201 implements wireless communication with the external device by controlling the connection unit 211.

The smartphone 200 can operate as a slave device in an infrastructure mode of wireless LAN communication and can participate in a network formed by a peripheral AP. The camera 100 may operate as a simple AP so that the smartphone 200 participates in the network formed by the camera 100.

A public network connection unit 212 is an interface used to perform public wireless communication. The smartphone 200 is connected to another device via the public network connection unit 212 and can execute data communication with the other device or make a call with a user of the other device. During the call, the control unit 201 acquires a voice signal via a microphone 213 or outputs a voice signal via a speaker 214. The public network connection unit 212 includes, for example, an interface for executing communication using 3G, 4G, or 5G. The communication system is not particularly limited and may be, for example, LTE, WiMAX, ADSL, or FTTH. The connection unit 211 and the public network connection unit 212 do not need to be configured as independent hardware, and for example, one antenna may function as both the connection unit 211 and the public network connection unit 212.

In the following description, there are cases where the smartphone 200 is described as the subject of processing. However, in practice, the control unit 201 implements various types of processing by reading and executing the program stored in the nonvolatile memory 203. Likewise, the camera 100 may be described as the subject of processing, but in practice, the control unit 101 implements various types of processing by reading and executing the programs stored in the nonvolatile memory 103.

### Screen Example of Smartphone

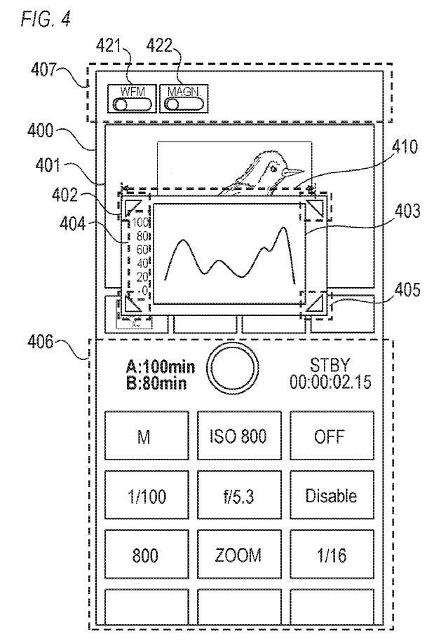

FIG. 4 is a schematic diagram illustrating a screen example of the camera control application displayed on the display unit 206 by the smartphone 200. The camera control application receives an LV image and various types of data of the camera 100 via communication with the camera 100, and allows the LV image and the data to be displayed on the display unit 206. The control unit 201 can execute control so that various areas (various types of information) are displayed on the screen of the camera control application. In FIG. 4, the control unit 201 is connected to the camera 100 by the camera control application, receives the LV image and various current setting values of the camera 100 from the camera 100, and displays the LV image and the setting values on a screen 400. The display unit 206 is a display unit capable of receiving a touch operation, such as a display unit on which a touch panel is formed.

An LV area 401 is an area where the LV image acquired from the camera 100 to be operated (hereinafter, simply referred to as the camera 100) is displayed. When a plurality of cameras 100 are connected to the smartphone 200, the control unit 201 selects any of the plurality of cameras 100 as the operation target in response to a user operation or the like. When the user touches (touchdown) the LV area 401, the control unit 201 executes a function related to the camera 100 (a function of controlling the camera 100). For example, the control unit 201 executes a function called touch focus. In the touch focus, an instruction to control the imaging optical system of the camera 100 (imaging apparatus) according to the touch position is output to the camera 100 so that the focus is achieved at the touch position. The function to be executed is not limited to the touch focus and, for example, may be a function of enlarging the LV image with the touch position as the center. The enlargement of the LV image may be digital zoom or optical zoom.

A superimposition area 402 is a quadrangular area for displaying information based on the LV image, and is superimposed on another area. For example, in the superimposition area 402, a feature image representing features of the LV image, such as an image of a waveform monitor (WFM image) or a luminance or color histogram of the LV image, is displayed. In the superimposition area 402, an enlarged image obtained by enlarging a part of the LV image (designated area) may be displayed.

In FIG. 4, the WFM image is displayed in the superimposition area 402. The WFM image is a graph in which the horizontal axis indicates the horizontal coordinates (coordinates in the horizontal direction) of the LV image and the vertical axis indicates the luminance value of the LV image, and indicates distribution of the luminance values of the LV image. The superimposition area 402 (WFM image) includes a plot area 403 in which the luminance value of the LV image is plotted and a scale area 404 in which a scale of the luminance value is displayed. The scale area 404 is disposed outside the plot area 403.

At four corners of the superimposition area 402, a touch detection area (area surrounded by a broken line) for detecting a touch as a touch on the superimposition area 402 (corner of the superimposition area 402) is set. When the user touches the touch detection area and executes a sliding operation of moving the touch position (touch-move), the control unit 201 changes (enlarges or reduces) the size of the superimposition area 402 (WFM image). When the user executes touchup to cancel (release) the touch, the size of the superimposition area 402 is confirmed. Hereinafter, the touch detection area for changing the size of the superimposition area 402 (WFM image) is referred to as a resizing touch area. In the resizing touch area, a resizing icon 405 as an item regarding resizing of the superimposition area 402 is displayed.

A width 410 is the size of the WFM image (superimposition area 402) in the horizontal direction when the user touches one resizing touch area (resizing icon 405) and performs a sliding operation. For example, the width 410 is a distance from the current touch position to the end of the superimposition area 402 on the side opposite to the touched side in the horizontal direction. Hereinafter, the width 410 is referred to as a WFM image width. Note that the size of the superimposition area 402 (WFM image) is also changed when the user touches two left and right resizing touch areas and performs a pinch operation to change the interval between the two touch positions. When the user performs the pinch operation, an interval between the two touch positions may be used as the WFM image width.

An area obtained by excluding the resizing touch area from the superimposition area 402 is also a touch detection area. When the user executes a sliding operation of touching the touch detection area (area obtained by excluding the resizing touch area from the superimposition area 402) and moving the touch position (touch-move), the control unit 201 moves the superimposition area 402 (WFM image). Hereinafter, the touch detection area for moving the superimposition area 402 will be referred to as a moving touch area. When the user executes touchup, the position of the superimposition area 402 is confirmed.

The resizing touch area may be disposed on four sides of the superimposition area 402 instead of the four corners of the superimposition area 402. The resizing icon 405 may not be displayed during normal time and may be displayed only when the user touches the resizing touch area. The moving touch area does not need to be the area obtained by excluding the resizing touch area from the superimposition area 402, and may be, for example, an upper side portion of the superimposition area 402 or a center portion of the superimposition area 402.

An operation area 406 is an area where an operation button group (operation item group) is displayed. The current setting value to be changed by an operation button may be displayed on the operation button. When the user executes a sliding operation of touching the operation area 406 and moving the touch position (touch-move), the control unit 201 scrolls the operation button group and displays the operation buttons that were not displayed in the operation area 406. Therefore, the control unit 201 does not execute the function corresponding to the operation button in response to the touch (touchdown) on the operation button, and executes the function corresponding to the operation button in response to the touchup. The function corresponding to the operation button is, for example, a function of instructing the camera 100 to change the setting value or a function of displaying an operation panel (operation menu). The scrolling of the operation button group may not be executed. Here, the operation button group may include an operation button for executing a function in response to a touch (touchdown) or an operation button for executing a function in response to a sliding operation.

A superimposition setting area 407 is an area where a switch for switching the display of the superimposition area 402 is displayed. In FIG. 4, a WFM switch 421 and an MAGN switch 422 are displayed on the superimposition setting area 407. When the user touches the WFM switch 421, the control unit 201 performs switching to enable/disable the display of the WFM image. When the user touches the MAGN switch 422, the control unit 201 performs switching to enable/disable the display of the enlarged image. When both the WFM image and the enlarged image are not displayed, the superimposition area 402 is not shown. The WFM image and the enlarged image may be displayed on two different superimposition areas, respectively, or may be displayed on the same superimposition area. When the display of the WFM image is enabled while displaying the enlarged image, the enlarged image may be hidden and the WFM image may be displayed, and when the display of the enlarged image is enabled while displaying the WFM image, the WFM image may be hidden and the enlarged image may be displayed.

Note that although an example in which the WFM image is displayed in the superimposition area 402 will be described, another graph having an axis indicating coordinates of the LV image in a predetermined direction and an axis indicating a gradation value of the LV image may be displayed in the superimposition area 402. In such a graph, an axis indicating coordinates in a predetermined direction of the LV image may be a vertical axis indicating vertical coordinates (coordinates in a vertical direction). An image different from the LV image (for example, a recorded captured image, an illustration being created, or the like) may be displayed in the LV area 401, and the graph may indicate a gradation value distribution of the image different from the LV image.

### Overall Operation of Smartphone

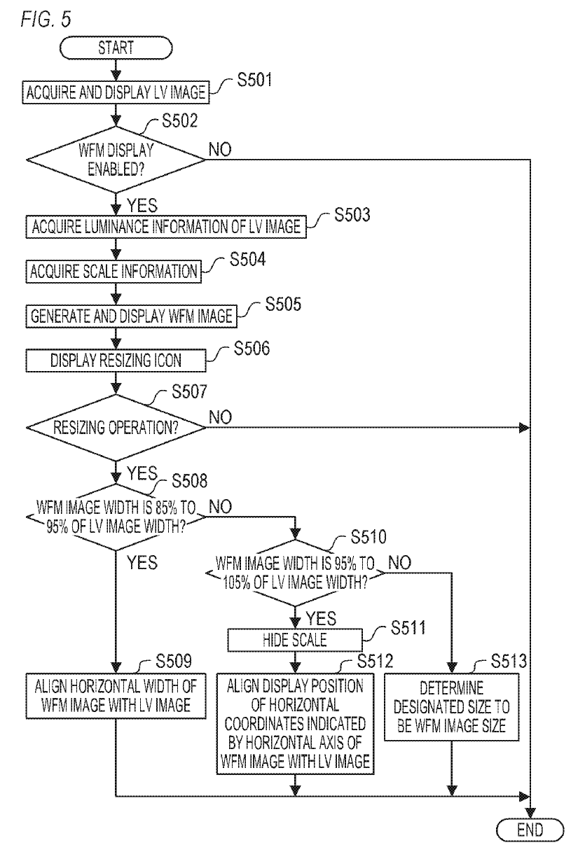

FIG. 5 is a flowchart illustrating an operation of the smartphone 200. The operation of FIG. 5 is implemented by the control unit 201 loading the program recorded in the nonvolatile memory 203 (for example, the program of the camera control application) on the working memory 204 and executing the program. For example, when the start of the camera control application is instructed, the operation of FIG. 5 starts. Furthermore, the operation of FIG. 5 is repeated at a predetermined cycle (for example, a cycle of display update (refresh rate) by the display unit 206, a cycle of imaging (imaging rate) or the like by the camera 100).

In S501, the control unit 201 acquires (receives) an LV image from the camera 100 via the connection unit 211, and displays the LV image on the display unit 206. The control unit 201 acquires the LV image from at least the operation target camera 100 among the one or more connected cameras 100. By the process of S501, a screen (not including the WFM image (superimposition area 402)) such as the screen 400 of FIG. 4 is displayed. Note that, when the process of S501 is performed while the WFM image is being displayed, the display of the LV image is updated while the WFM image is being displayed.

In S502, the control unit 201 determines whether or not the display of the WFM image is set to be enabled. When the display of the WFM image is set to be enabled, the process proceeds to S503, and otherwise, the operation of FIG. 5 ends.

In S503, the control unit 201 analyzes the LV image acquired from the operation target camera 100 in S501 (hereinafter, simply described as the LV image), and acquires luminance information of the LV image (luminance value of each coordinate).

In S504, the control unit 201 generates (acquires) scale information indicating a scale of the luminance value (scale to be displayed) on the basis of the luminance information acquired in S503.

In S505, the control unit 201 generates a WFM image on the basis of the luminance information acquired in S503 and the scale information acquired in S504, and displays the generated WFM image on the display unit 206. For example, a WFM image including a scale outside the plot area is generated and displayed. By the process of S505, a screen (including the WFM image (superimposition area 402)) such as the screen 400 of FIG. 4 is displayed. When the process of S505 is performed after the scale is hidden in S511 described later, the display of the WFM image is updated while the WFM image does not include the scale.

Note that although the smartphone 200 (the control unit 201) acquires the luminance information and the scale information from the LV image and generates the WFM image on the basis of these pieces of information, the method of generating the WFM image is not limited thereto. For example, the smartphone 200 (the control unit 201) may acquire the luminance information and the scale information from the camera 100 and generate the WFM image on the basis of these pieces of information.

In S506, the control unit 201 displays a resizing icon for changing the size of the WFM image to be superimposed on the WFM image.

In S507, the control unit 201 determines whether or not a user operation to change the size of the WFM image (resizing operation) has been performed. The resizing operation is, for example, a sliding operation of touching the resizing icon (resizing touch area) and moving the touch position, and the like. When the resizing operation has been performed, the process proceeds to S508, and otherwise, the operation of FIG. 5 ends.

In S508, the control unit 201 determines whether or not the ratio between the LV image width (the size of the LV image in the horizontal direction) and the WFM image width is within a predetermined range. Although the ratio of the WFM image width to the LV image width is used in the first embodiment, the ratio of the LV image width to the WFM image width may be used. The predetermined range is not particularly limited. It is assumed that the WFM image is enlarged so that the size of the WFM image approaches the size of the LV image, or the WFM image is reduced so that the size of the WFM image deviates from the size of the LV image. In this case, the predetermined range is, for example, a range between 85% or more and less than 95%, a range between 85% or more and less than 90%, or the like. When the ratio is within the predetermined range, the process proceeds to S509, and otherwise (when the ratio is out of the predetermined range), the process proceeds to S510.

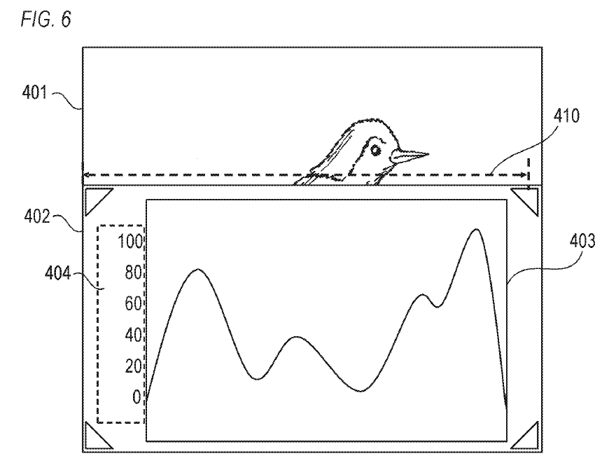

In S509, the control unit 201 changes the size of the WFM image so that the horizontal width of the WFM image including the plot area and the scale area matches (substantially matches) the horizontal width of the LV image. FIG. 6 is a schematic diagram illustrating an example of the LV image and the WFM image displayed in S509.

In S510, similarly to S508, the control unit 201 determines whether or not the ratio between the LV image width and the WFM image width is within a predetermined range. The predetermined range in S510 is also not particularly limited, but the predetermined range in S510 is closer to 100% than the predetermined range in S508. It is assumed that the WFM image is enlarged so that the size of the WFM image approaches the size of the LV image, or the WFM image is reduced so that the size of the WFM image deviates from the size of the LV image. In this case, the predetermined range in S510 is, for example, a range between 95% or more and less than 105%, a range between 90% or more and less than 100%, or the like. When the ratio is within the predetermined range, the process proceeds to S511, and otherwise (when the ratio is out of the predetermined range), the process proceeds to S513.

In S511, the control unit 201 hides the scale of the WFM image. The hidden scale is displayed again at the timing of, for example, S509 or S513 (described later).

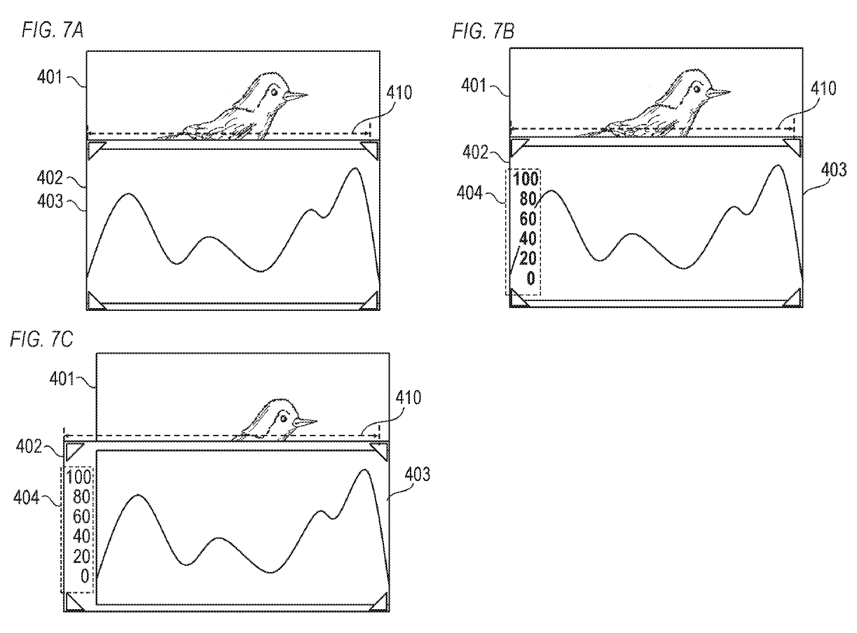

In S512, the control unit 201 changes the size of the WFM image so that the display position of the horizontal coordinates indicated by the horizontal axis of the WFM image and the display position of the horizontal coordinates of the LV image match (substantially match). For example, the size of the WFM image is changed so that the horizontal width of the plot area and the horizontal width of the LV image match (substantially match). FIG. 7A is a schematic diagram illustrating an example of the LV image and the WFM image displayed in S512.

Note that, in the present embodiment, an example has been described in which the scale is hidden when the display position of the horizontal coordinates indicated by the horizontal axis of the WFM image and the display position of the horizontal coordinates of the LV image match (substantially match). However, the scale may be displayed inside the plot area as illustrated in FIG. 7B. Even if the display position of the horizontal coordinates indicated by the horizontal axis of the WFM image and the display position of the horizontal coordinates of the LV image match (substantially match), when a space (margin) remains outside the plot area, the scale may be continuously displayed outside the plot area. For example, as illustrated in FIG. 7C, when the LV image is vertically longer than the LV area, a space capable of displaying the scale remains outside the plot area. Since the aspect ratio of the display surface of the smartphone 200 also varies, as illustrated in FIG. 7D, even in the case where the full-screen display of the LV image is performed, a space where the scale can be displayed may remain outside the plot area.

In S513, the control unit 201 determines the size designated by the user as the size of the WFM image.

As described above, in the first embodiment, the display of the LV image and the WFM image is switched between the display in which the display position of the horizontal coordinates indicated by the horizontal axis of the WFM image and the display position of the horizontal coordinates of the LV image substantially match and the display in which the display positions do not substantially match, according to a predetermined user operation. This makes it possible to switch the display of the LV image and the WFM image between normal display in which the absolute luminance value of the LV image can be easily grasped and display in which the correspondence relationship between the luminance value and the position in the LV image can be easily grasped. As a result, the user can easily grasp the absolute luminance value of the LV image and the correspondence relationship between the luminance value and the position in the LV image. Hereinafter, the display in which the display position of the horizontal coordinates indicated by the horizontal axis of the WFM image and the display position of the horizontal coordinates of the LV image substantially match is referred to as position confirmation display, and the display in which the display positions do not substantially match is referred to as luminance confirmation display.

Note that the example in which the resizing operation is performed and the display of the WFM image (the display of the LV image and the WFM image) is switched according to the ratio between the LV image width and the WFM image width after the resizing operation has been described, but the switching method is not limited thereto. Display of the LV image and the WFM image may be switched in response to a user operation different from the resizing operation. For example, the display of the LV image and the WFM image may be switched in response to a user operation to switch the display mode to be used between the display mode for performing the position confirmation display and the display mode for performing the luminance confirmation display.

The example in which the same threshold (the predetermined range in S510) is used for switching from one to the other of the position confirmation display and the luminance confirmation display and switching from the other to the one has been described, but the present disclosure is not limited thereto. The predetermined range at the time of switching from the position confirmation display to the luminance confirmation display may include at least a part of the predetermined range at the time of switching from the luminance confirmation display to the position confirmation display. In order to immediately switch from the position confirmation display to the luminance confirmation display, the predetermined range at the time of switching from the position confirmation display to the luminance confirmation display may be a part of the predetermined range at the time of switching from the luminance confirmation display to the position confirmation display. When the resizing operation is performed while the position confirmation display is being performed, switching from the position confirmation display to the luminance confirmation display may be performed regardless of the ratio between the LV image width and the WFM image width. When the resizing operation for enlarging the size of the WFM image is performed in the state of S509, switching from the luminance confirmation display to the position confirmation display may be performed regardless of the ratio between the LV image width and the WFM image width. The state of S509 is a state in which the luminance confirmation display is performed, and the horizontal width of the WFM image including the plot area and the scale area and the horizontal width of the LV image match (substantially match).

The display of the LV image and the WFM image may be switched in consideration of not only the ratio between the LV image width and the WFM image width but also the positional relationship between the LV image and the WFM image. A case where the ratio between the LV image width and the WFM image width falls within the predetermined range of S510 by the resizing operation, in the state where the luminance confirmation display is performed, will be considered. In this case, when the position of an end of the LV image and the position of an end of the WFM image on the same side as the end of the LV image match (substantially match) in the horizontal direction, switching to the position confirmation display may be performed, but when the display positions do not match (substantially match), the switching may not be performed. As a result, it is possible to prevent the scale from being hidden against the user's intention.

The display of the LV image and the WFM image may be switched in consideration of overlapping between the LV image and the WFM image, the distance between the LV image and the WFM image, and the like. A case where the ratio between the LV image width and the WFM image width falls within the predetermined range of S510 by the resizing operation, in the state where the luminance confirmation display is performed, will be considered. In this case, switching to the position confirmation display is performed when the LV image and the WFM image do not overlap, but the switching may not be performed when the LV image and the WFM image overlap. When the distance between the LV image and the WFM image falls within the predetermined range, switching to the position confirmation display is performed, but when the distance between the LV image and the WFM image falls outside the predetermined range, the switching may not be performed. As a result, switching to the position confirmation display can be performed only when comparison between the LV image and the WFM image is easy (when the LV image and the WFM image do not overlap each other and are not too far away from each other).

It has been assumed that the WFM image is enlarged so that the size of the WFM image approaches the size of the LV image, or the WFM image is reduced so that the size of the WFM image deviates from the size of the LV image. However, other cases may be assumed. For example, it is acceptable to assume that the WFM image is reduced so that the size of the WFM image approaches the size of the LV image, or the WFM image is enlarged so that the size of the WFM image deviates from the size of the LV image. In this case, in S508, a range between 105% or more and less than 115%, a range between 110% or more and less than 115%, or the like may be used as the predetermined range. In S510, a range between 95% or more and less than 105%, a range between 100% or more and less than 110%, or the like may be used as the predetermined range.

The resizing operation may be a user operation to change the size of the LV image. Even in this case, the ratio used in S508 or S510 may be the ratio of the WFM image width to the LV image width or the ratio of the LV image width to the WFM image width. The predetermined range used in S508 and the predetermined range used in S510 are not particularly limited. For example, in S510, the control unit 201 may determine whether or not the ratio of the LV image width to the WFM image width is 95% or more and less than 105%. Then, when the ratio of the LV image width to the WFM image width is 95% or more and less than 105%, the process may proceed to S511, and otherwise, the process may proceed to S513.

When the luminance confirmation display is performed, the WFM image in which the luminance value of the LV image is plotted in a mode in which the luminance value of a specific area in the LV image can be identified may be generated and displayed, and the LV image may be displayed in a mode in which the specific area can be identified. The specific area is, for example, an area designated by the user, an area including a face, or the like. As a result, even when the luminance confirmation display is performed, the user can easily grasp the luminance value of the specific area. When the position confirmation display is performed, such an identifiable display may not be performed.

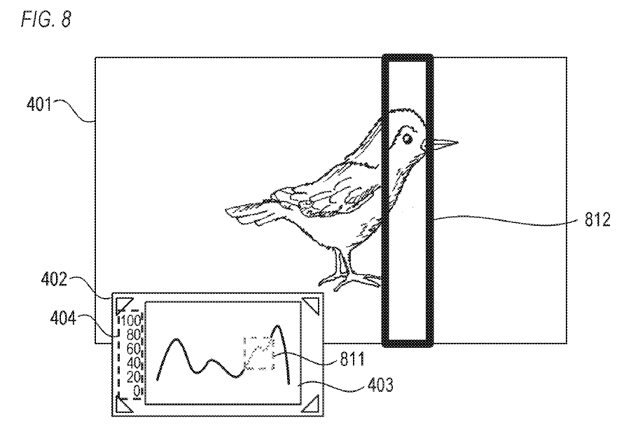

FIG. 8 is a schematic diagram illustrating a display example of an LV image and a WFM image. In FIG. 8, luminance confirmation display is performed. Here, it is assumed that a partial area of the LV image is designated. In FIG. 8, an auxiliary line 812 indicating the designated area is superimposed on the LV image. In the waveform (a plurality of plotted luminance values) displayed in the plot area 403, a portion corresponding to the designated area is displayed in a color different from the other portions, and an auxiliary line 811 indicating the portion corresponding to the designated area is superimposed on the waveform. Note that the user may designate a portion of the waveform. Then, the designated portion in the waveform displayed in the plot area 403 and the area corresponding to the designated portion in the LV image may be highlighted.

When the position confirmation display is performed, a WFM image in which luminance values of the LV image are plotted may be generated and displayed in a mode in which luminance values outside the predetermined range (for example, luminance values of blown-out highlights and blocked-up shadows) can be identified. Accordingly, even when the scale is not displayed, the user can easily grasp whether or not the luminance value is within the predetermined range.

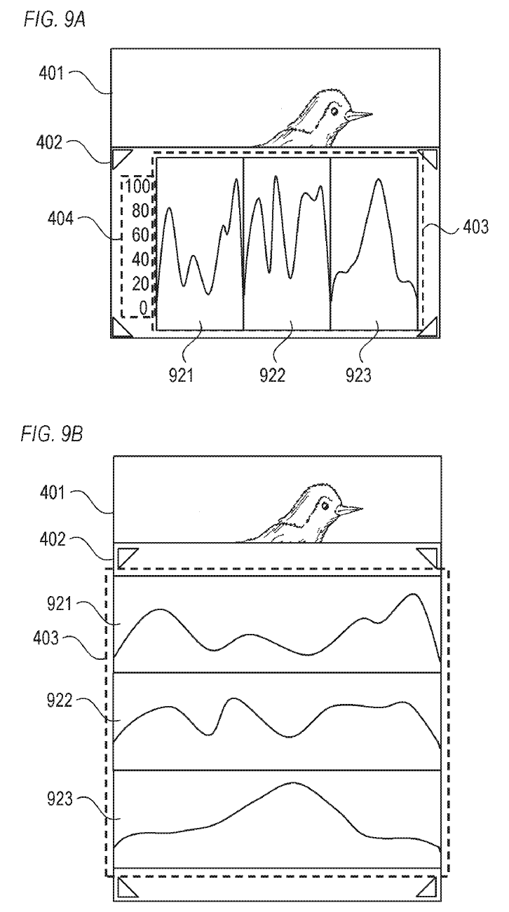

Although the example of generating one WFM image has been described, a plurality of graphs may be generated and displayed. For example, a plurality of graphs in which each horizontal axis indicates the horizontal coordinates of the LV image may be generated. As a plurality of graphs, a graph indicating the distribution of R values of the LV image, a graph indicating the distribution of G values of the LV image, and a graph indicating the distribution of B values of the LV image may be generated. As a plurality of graphs, a graph indicating the distribution of Y values of the LV image, a graph indicating the distribution of Cb values of the LV image, and a graph indicating the distribution of Cr values of the LV image may be generated. The number of the plurality of graphs is not particularly limited, and may be more or less than three. In this case, in the position confirmation display, as illustrated in FIG. 9B, a plurality of graphs (graphs 921 to 923) may be arranged vertically so that the display position of the horizontal coordinates and the display position of the horizontal coordinates of the LV image indicated by the horizontal axis of each graph match (substantially match). In this way, the user can easily compare the plurality of graphs with the LV image. In the display for confirming the absolute gradation value such as the luminance confirmation display, as illustrated in FIG. 9A, a plurality of graphs (graphs 921 to 923) may be arranged horizontally so as to share one vertical axis. As a result, the space of the scale can be minimized.

### Second Embodiment

Hereinafter, a second embodiment of the present disclosure will be described. The description of the same portions as those of the first embodiment will not be repeated.

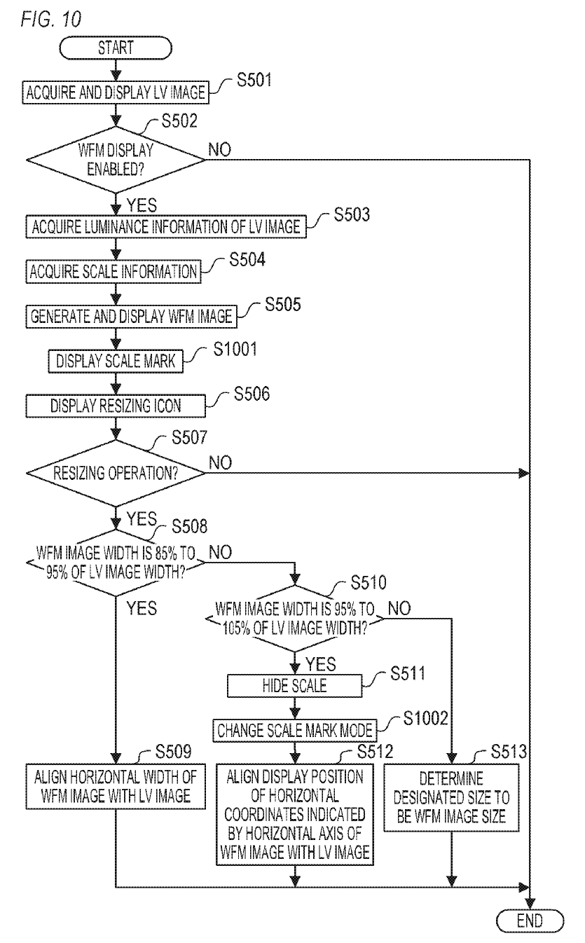

FIG. 10 is a flowchart illustrating an operation of a smartphone 200 according to a second embodiment. The operation of FIG. 10 is implemented by the control unit 201 loading the program recorded in the nonvolatile memory 203 (for example, the program of the camera control application) on the working memory 204 and executing the program. For example, when the start of the camera control application is instructed, the operation of FIG. 10 starts. Furthermore, the operation of FIG. 10 is repeated at a predetermined cycle (for example, a cycle of display update (refresh rate) by the display unit 206, a cycle of imaging (imaging rate) by the camera 100, and the like).

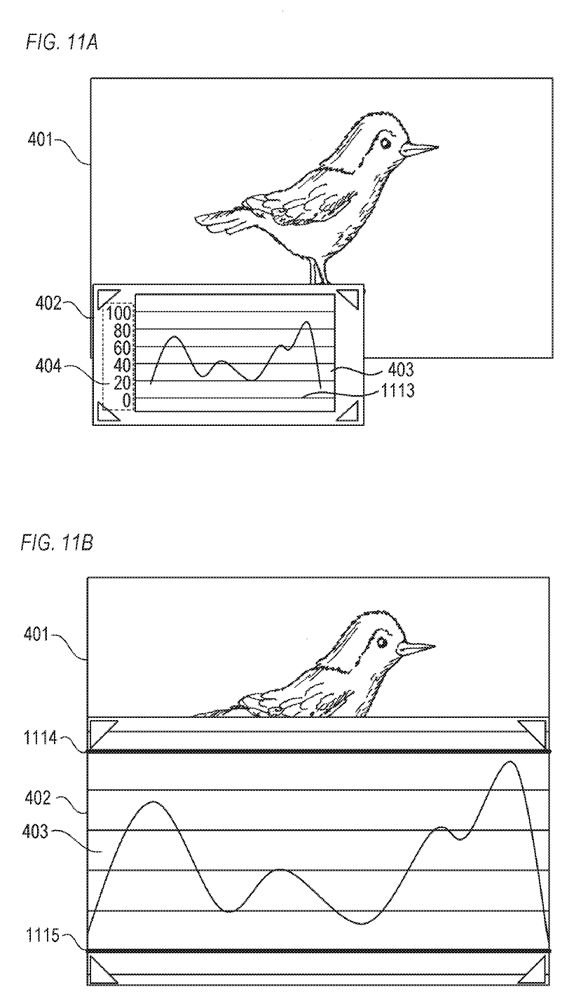

In S1001, the control unit 201 draws a scale mark of the luminance value on the WFM image generated in S505. FIG. 11A is a schematic diagram illustrating an example of the LV image and the WFM image displayed in S1001. A scale mark 1113 is drawn in the WFM image. When the process of S1001 is performed after the mode of the scale mark is changed in S1002 described later, the scale mark is drawn in the changed mode.

In S1002, the control unit 201 changes the mode of the scale mark. In the second embodiment, the mode of the scale mark indicating the luminance value smaller than the upper limit value and larger than the lower limit value is not changed, and the mode of the scale mark indicating the upper limit value and the mode of the scale mark indicating the lower limit value are changed. FIG. 11B is a schematic diagram illustrating an example of the LV image and the WFM image displayed in S1002. The scale mark 1114 indicating the upper limit value and the scale mark 1115 indicating the lower limit value are emphasized as compared with FIG. 11A. As a result, even if the scale is hidden, the user can compare the plotted luminance value with the scale marks 1114 and 1115 to easily grasp whether or not blown-out highlights or blocked-up shadows have occurred. The change (highlight) of the scale mark is canceled at the timing of S509 or S513, for example.

In FIG. 11B, the scale mark is highlighted by thickening the scale mark, but the method of changing the scale mark is not particularly limited. The line type or color of the scale mark may be changed. Although the example in which the mode of the scale mark indicating the upper limit value and the mode of the scale mark indicating the lower limit value are changed has been described, other scale marks may be changed. All the scale marks may be changed. The change of the scale mark may not be highlighting of the scale mark.

As described above, in the second embodiment, a WFM image including a scale mark of the luminance value is generated, and when the position confirmation display is performed, a WFM image including a scale mark in a mode different from that in the case where the luminance confirmation display is performed is generated. As a result, the user can be urged to pay attention to the scale mark, and even if the scale is hidden, the user can easily grasp the luminance value with high quantitativity by comparing the plotted luminance value with the scale mark.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to allow a user to easily grasp an absolute luminance value of an image and a correspondence relationship between the luminance value and a position in the image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025- 047189, filed Mar. 21, 2025, which is hereby incorporated by reference herein in its entirety.

What is claimed is:

1. An electronic device comprising:
a processor; and
a memory storing a program which, when executed by the processor, causes the electronic device to:
execute an acquisition process of acquiring an image;
execute a generation process of generating a graph including a first axis indicating coordinates of the image in a predetermined direction and a second axis indicating a gradation value of the image; and
execute a control process of performing control to display the image and the graph, wherein
in response to a user operation, in the control process, control is performed to switch display of the image and the graph between first display and second display, the first display being display in which a display position of coordinates indicated by the first axis and a display position of the coordinates of the image do not substantially match in the predetermined direction, the second display being display in which the display position of the coordinates indicated by the first axis and the display position of the coordinates of the image substantially match in the predetermined direction.

2. The electronic device according to claim 1, wherein
the graph is an image of a waveform monitor.

3. The electronic device according to claim 1, wherein
in a case where the first display is performed, in the generation process, a graph including a scale of the gradation value outside a plot area in which the gradation value is plotted is generated.

4. The electronic device according to claim 1, wherein
in a case where the second display is performed, in the generation process, a graph not including a scale of the gradation value is generated.

5. The electronic device according to claim 1, wherein
in a case where the second display is performed, in the generation process, a graph including a scale of the gradation value inside a plot area in which the gradation value is plotted is generated.

6. The electronic device according to claim 1, wherein
the user operation is a user operation to change a size of the image or a size of the graph, and
in a state in which the first display is performed, in a case where the user operation is performed so that a ratio between the size of the image in the predetermined direction and the size of the graph in the predetermined direction falls within a first predetermined range, in the control process, control is performed to switch the display of the image and the graph from the first display to the second display.

7. The electronic device according to claim 6, wherein
the user operation is a user operation to change the size of the graph, and
in the state in which the first display is performed, in a case where the user operation is performed so that a ratio of the size of the graph in the predetermined direction to the size of the image in the predetermined direction falls within the first predetermined range, in the control process, control is performed to switch the display of the image and the graph from the first display to the second display.

8. The electronic device according to claim 6, wherein
the user operation is a user operation to change the size of the image, and
in the state in which the first display is performed, in a case where the user operation is performed so that a ratio of the size of the image in the predetermined direction to the size of the graph in the predetermined direction falls within the first predetermined range, in the control process, control is performed to switch the display of the image and the graph from the first display to the second display.

9. The electronic device according to claim 6, wherein
in the state in which the first display is performed, in a case where the user operation is performed so that the ratio between the size of the image in the predetermined direction and the size of the graph in the predetermined direction falls within the first predetermined range but a display position of an end of the image and a display position of an end of the graph on a same side as the end of the image do not substantially match in the predetermined direction, in the control process, control to switch the display of the image and the graph from the first display to the second display is not performed.

10. The electronic device according to claim 6, wherein
in the state in which the first display is performed, in a case where the user operation is performed so that the ratio between the size of the image in the predetermined direction and the size of the graph in the predetermined direction falls within the first predetermined range but the image and the graph overlap each other, in the control process, control to switch the display of the image and the graph from the first display to the second display is not performed.

11. The electronic device according to claim 6, wherein
in the state in which the first display is performed, in a case where the user operation is performed so that the ratio between the size of the image in the predetermined direction and the size of the graph in the predetermined direction falls within the first predetermined range but a distance between the image and the graph falls outside the predetermined range, in the control process, control to switch the display of the image and the graph from the first display to the second display is not performed.

12. The electronic device according to claim 6, wherein
in a state in which the first display is performed and the size of the graph in the predetermined direction and the size of the image in the predetermined direction substantially match, in a case where the user operation is performed to enlarge the size of the graph, in the control process, control is performed to switch the display of the image and the graph from the first display to the second display.

13. The electronic device according to claim 6, wherein
in a state in which the second display is performed, in a case where the user operation is performed, in the control process, control is performed to switch the display of the image and the graph from the second display to the first display.

14. The electronic device according to claim 6, wherein
in a state in which the second display is performed, in a case where the user operation is performed so that the ratio between the size of the image in the predetermined direction and the size of the graph in the predetermined direction falls outside a second predetermined range including at least a part of the first predetermined range, in the control process, control is performed to switch the display of the image and the graph from the second display to the first display.

15. The electronic device according to claim 14, wherein
the second predetermined range is equal to the first predetermined range.

16. The electronic device according to claim 14, wherein
the second predetermined range is a part of the first predetermined range.

17. The electronic device according to claim 1, wherein
in the generation process, a graph including a scale mark of the gradation value is generated, and in a case where the second display is performed, a graph including a scale mark of a mode different from a case in which the first display is performed is generated.

18. The electronic device according to claim 17, wherein
in a case where the second display is performed, in the generation process, a graph including a scale mark that is highlighted compared with the case in which the first display is performed is generated.

19. A control method of an electronic device, comprising:
acquiring an image;
generating a graph including a first axis indicating coordinates of the image in a predetermined direction and a second axis indicating a gradation value of the image;
performing control to display the image and the graph; and
performing, in response to a user operation, control to switch display of the image and the graph between first display and second display, the first display being display in which a display position of coordinates indicated by the first axis and a display position of the coordinates of the image do not substantially match in the predetermined direction, the second display being display in which the display position of the coordinates indicated by the first axis and the display position of the coordinates of the image substantially match in the predetermined direction.

20. A non-transitory computer readable medium that stores a program, wherein the program causes a computer to execute a control method of an electronic device, the control method comprising:
acquiring an image;
generating a graph including a first axis indicating coordinates of the image in a predetermined direction and a second axis indicating a gradation value of the image;
performing control to display the image and the graph; and
performing, in response to a user operation, control to switch display of the image and the graph between first display and second display, the first display being display in which a display position of coordinates indicated by the first axis and a display position of the coordinates of the image do not substantially match in the predetermined direction, the second display being display in which the display position of the coordinates indicated by the first axis and the display position of the coordinates of the image substantially match in the predetermined direction.
